(19) United States
(12) Patent Application Publication
(10) Pub. No.: US 2024/0288705 A1
(43) Pub. Date: Aug. 29, 2024

(54) EXIT PUPIL EXPANDER LEAKS CANCELLATION

(71) Applicant: InterDigital CE Patent Holdings, SAS, Paris (FR)

(72) Inventors: Valter DRAZIC, Betton (FR); Vincent BRAC DE LA PERRIERE, RENNES (FR)

(21) Appl. No.: 18/572,751

(22) PCT Filed: Jun. 23, 2022
(86) PCT No.: PCT/EP2022/067177

§ 371 Date: Dec. 20, 2023

(30) Foreign Application Priority Data
Jun. 25, 2021 (EP) 21305878.7

(51) Int. Cl. G02B 27/42; G02B 27/00; G02B 27/01

(52) U.S. Cl. CPC G02B 27/4205; G02B 27/0081; G02B 27/0103; G02B 27/017; G02B 2027/0132; G02B 2027/0178

(57) ABSTRACT

In example embodiments, an apparatus includes a waveguide having an in-coupler, an out-coupler, and at least one exit pupil expander along an optical path from the in-coupler to the out-coupler. A holographic optical element is provided on a surface of the waveguide substantially opposite the exit pupil expander. The holographic optical element being configured to selectively reflect light having a first characteristic and to selectively transmit light that does not have the first characteristic. The first characteristic may include light having an incident angle greater than a threshold angle, light having a propagation direction along the optical path from the in-coupler to the out-coupler, and/or light having a selected wavelength.

### CROSS-REFERENCE TO RELATED APPLICATION

This application claims priority of European Patent Application No. EP21305878, filed 25 Jun. 2021, which is incorporated herein by reference in its entirety.

### BACKGROUND

The present disclosure relates to the field of optics and photonics, and more specifically to planar optical devices. More particularly, but not exclusively, the present disclosure relates to diffraction gratings that can be used in a wide range of devices, such as, among other examples, displays, including in- and out-coupling of light in waveguides for eyewear electronic devices and head-mounted displays for AR (Augmented Reality) and VR (Virtual Reality) glasses, head up displays (HUD), as for example in the automotive industry, optical sensors for photo/video/lightfield cameras, bio/chemical sensors, including lab-on-chip sensors, microscopy, spectroscopy and metrology systems, and solar panels.

This section is intended to introduce the reader to various aspects of art, which may be related to various aspects of the present disclosure that are described and/or claimed below. This discussion is believed to be helpful in providing the reader with background information to facilitate a better understanding of the various aspects of the present invention. Accordingly, it should be understood that these statements are to be read in this light, and not as admissions of prior art.

AR/VR glasses are under consideration for a new generation of human-machine interface. Development of AR/VR glasses (and more generally eyewear electronic devices) is associated with a number of challenges, including reduction of size and weight of such devices as well as improvement of the image quality (in terms of contrast, field of view, color depth, etc.) that should be realistic enough to enable a truly immersive user experience.

The tradeoff between the image quality and physical size of the optical components motivates research into ultra-compact optical components that can be used as building blocks for more complex optical systems, such as AR/VR glasses. It is desirable for such optical components to be easy to fabricate and replicate. In such AR/VR glasses, various types of refractive and diffractive lenses and beam-forming components are used to guide the light from a micro-display or a projector towards the human eye, allowing forming a virtual image that is superimposed with an image of the physical world seen with a naked eye (in case of AR glasses) or captured by a camera (in case of VR glasses).

Some of kinds of AR/VR glasses utilize an optical waveguide wherein light propagates into the optical waveguide by TIR (for Total Internal Reflection) only over a limited range of internal angles. The FoV (for Field of View) of the waveguide depends on the material of the waveguide, among other factors.

### SUMMARY

References in the specification to “one embodiment,” “an embodiment,” “an example embodiment,” and the like indicate that the embodiment described may include a particular feature, structure, or characteristic; but not every embodiment necessarily includes that particular feature, structure, or characteristic. Moreover, such phrases are not necessarily referring to the same embodiment. Further, when a particular feature, structure, or characteristic is described in connection with an embodiment, such feature, structure, or characteristic may be used in connection with other embodiments whether or not explicitly described.

An apparatus according to some embodiments comprises a waveguide having an in-coupler, an out-coupler, and at least one exit pupil expander along an optical path from the in-coupler to the out-coupler; and a holographic optical element on at least a portion of a surface of the waveguide opposite the exit pupil expander. The holographic optical element is configured as one or both of a wavelength-selective mirror or an angle-selective mirror.

In some embodiments, the apparatus further comprises an image generator, the in-coupler being configured to in-couple an image generated by the image generator, and the holographic optical element is configured as a wavelength-selective mirror. A reflectance of the wavelength-selective mirror has at least one peak at a wavelength of light emitted by the image generator.

In some embodiments, the holographic optical element is configured as an angle-selective mirror, and the angle-selective mirror has a reflectance that increases for increasing angle of incidence.

In some embodiments, the angle-selective mirror is configured to substantially transmit light having an incident angle less than a threshold angle and to substantially reflect light having an incident angle greater than a threshold angle. The threshold may be between 30 and 40 degrees. The threshold may be 35 degrees.

In some embodiments, the holographic optical element is configured as an angle-selective mirror having a reflectance that depends on an azimuth angle of incident light. In some such embodiments, the angle-selective mirror has a maximum reflectance for light with an azimuth angle directed along an optical path from the in-coupler to the out-coupler.

In some embodiments, the exit pupil expander comprises a diffraction grating.

A method according to some embodiments comprises coupling light into an in-coupler of a waveguide having an out-coupler and at least one exit pupil expander along an optical path from the in-coupler to the out-coupler; and, using a holographic optical element on at least a portion of a surface of the waveguide opposite the exit pupil expander, selectively reflecting or transmitting the light based on either or both of a wavelength of the light or an angle of the light.

Some embodiments of the method further comprise emitting light from an image generator, the light coupled by the in-coupler including the emitted light. The holographic optical element is configured as a wavelength-selective mirror, with a reflectance of the wavelength-selective mirror having at least one peak at a wavelength of the light emitted by the image generator.

In some embodiments, the holographic optical element is configured as an angle-selective mirror, the angle-selective mirror having a reflectance that increases for increasing angle of incidence. In some such embodiments, the angle-selective mirror is configured to substantially transmit light having an incident angle less than a threshold angle and to substantially reflect light having an incident angle greater than a threshold angle.

In some embodiments, the holographic optical element is configured as an angle-selective mirror having a reflectance that depends on an azimuth angle of incident light. In some such embodiments, the angle-selective mirror has a maximum reflectance for light with an azimuth angle directed along an optical path from the in-coupler to the out-coupler.

In some embodiments, ambient light is permitted to enter the waveguide, and the holographic optical element selectively transmits at least a portion of the ambient light.

### BRIEF DESCRIPTION OF THE DRAWINGS

FIG. 1A is a cross-sectional schematic view of a waveguide display.

FIG. 1B is a schematic illustration of a binocular waveguide display with a first layout of diffractive optical components.

FIG. 1C is a schematic illustration of a binocular waveguide display with a second layout of diffractive optical components.

FIG. 1D is a schematic exploded view of a double-waveguide display according to some embodiments.

FIG. 1E is a cross-sectional schematic view of a double-waveguide display according to some embodiments.

FIG. 1F schematically illustrates a portion of the optical architecture of a waveguide type AR glass, including an in-coupler which is the round shape, and the exit pupil expander (EPE), which is the rotated rectangle.

FIG. 2A illustrates polar angles after diffraction by the EPE, and FIG. 2B illustrates azimuth angles after diffraction by the EPE, for rays with an initial azimuth angle of 0°. Both curves are illustrated as a function of the incident polar angle on the EPE from inside of the waveguide.

FIG. 3A illustrates polar angles after diffraction by the EPE, and FIG. 3B illustrates azimuth angles after diffraction by the EPE, for rays with an initial azimuth angle of −14°. Both curves are illustrated as a function on the incident polar angle on the EPE from inside of the waveguide.

FIG. 4A is a k-vector diagram illustrating relative values of wavevectors processed by a waveguide.

FIG. 4B is a graph illustrating regions of a display that are propagated (dotted region) and not propagated (black region) through a waveguide.

FIG. 5 is a schematic side view of a waveguide (WG) region with an EPE.

FIG. 6 is a schematic top view of an EPE region of a waveguide.

FIG. 7 is a schematic side view of an example waveguide with an in-coupler, an EPE, and an anti-leak HOE component.

FIG. 8 is a schematic top view of the system of FIG. 7.

FIG. 9 is a schematic side view of a process of recording a holographic optical element.

FIG. 10 is a schematic perspective view of a waveguide display according to some embodiments.

FIG. 11 is a schematic perspective view of a waveguide display according to some embodiments.

### DETAILED DESCRIPTION

The present disclosure relates to the field of optics and photonics, and more specifically to optical devices comprising at least one diffraction grating. Diffraction gratings as described herein may be employed in the field of conformable and wearable optics, such as AR/VR glasses, as well as in a variety of other electronic consumer products comprising displays and/or lightweight imaging systems. Example devices for application may include head-mounted displays (HMD) and lightfield capture devices. Such diffraction grating modulating the unpolarized light may find application in solar cells.

Example optical devices are described that include one or more diffraction gratings that can be used for in-coupling light into the optical device and/or out coupling light from the optical device. Such optical devices can be used as a waveguide for AR/VR glasses for instance.

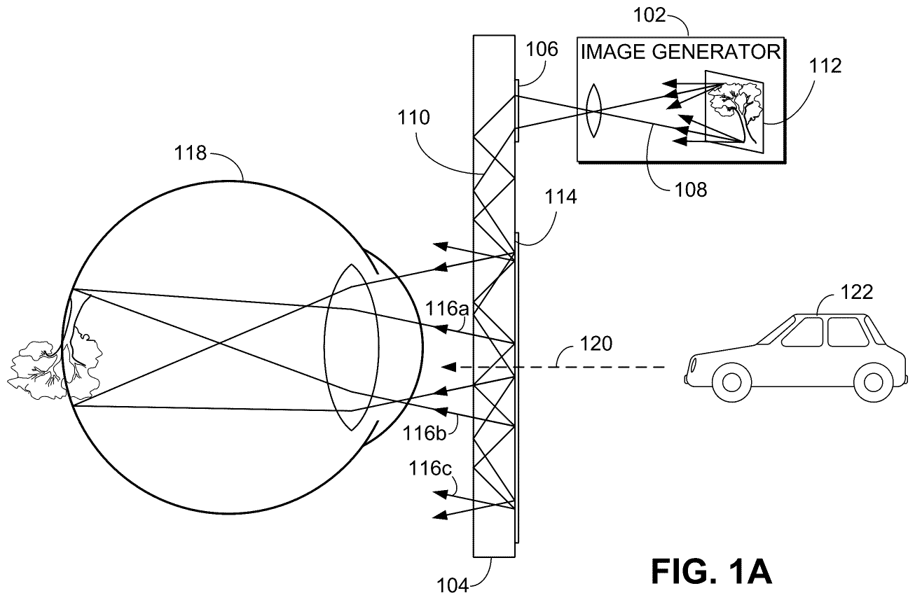

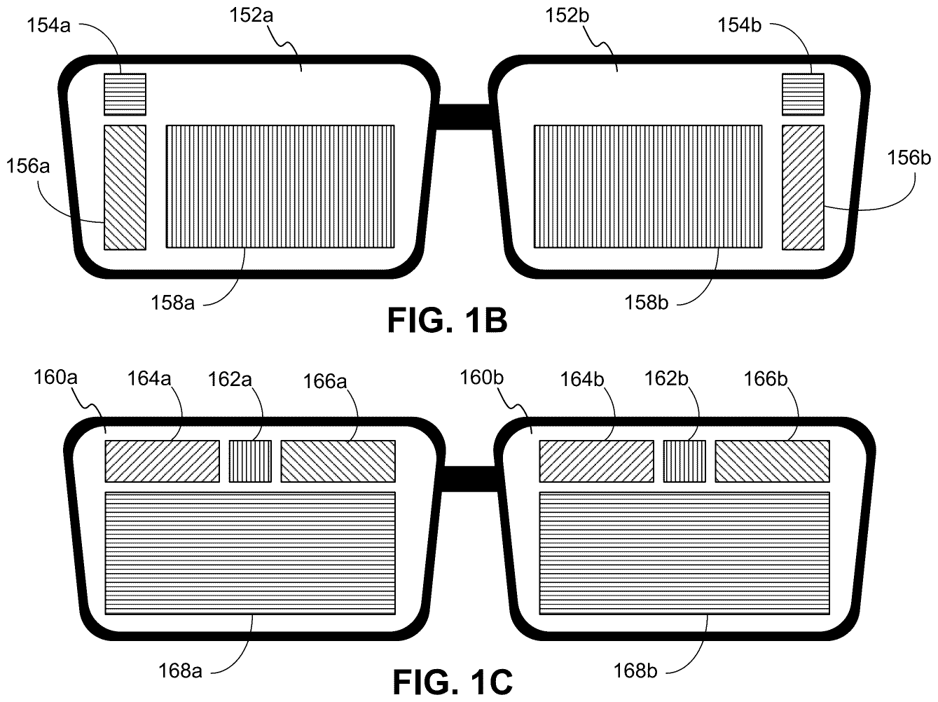

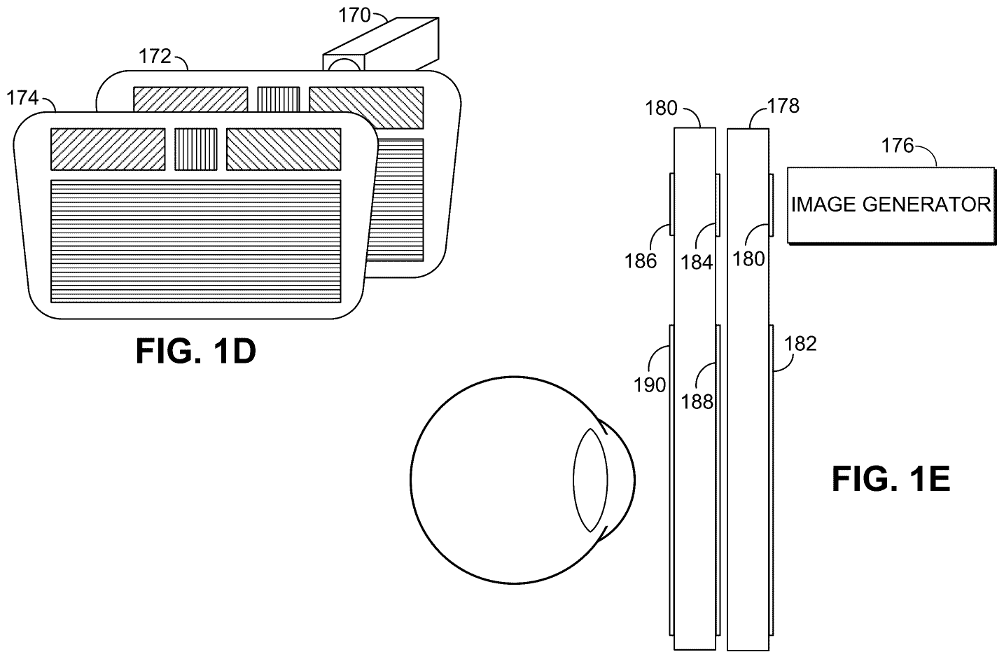

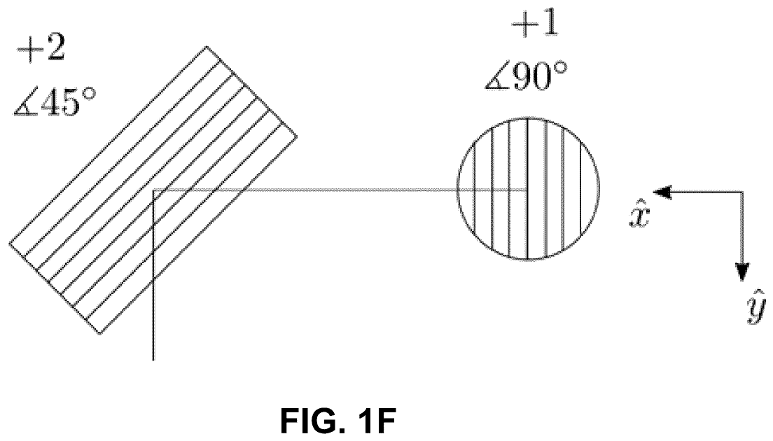

An example waveguide display device that may employ diffraction grating structures as described herein is illustrated in FIG. 1A. FIG. 1A is a schematic cross-sectional side view of a waveguide display device in operation. An image is projected by an image generator 102. The image generator 102 may use one or more of various techniques for projecting an image. For example, the image generator 102 may be a laser beam scanning (LBS) projector, a liquid crystal display (LCD), a light-emitting diode (LED) display (including an organic LED (OLED) or micro LED (μLED) display), a digital light processor (DLP), a liquid crystal on silicon (LCoS) display, or other type of image generator or light engine.

Light representing an image 112 generated by the image generator 102 is coupled into a waveguide 104 by a diffractive in-coupler 106. The in-coupler 106 diffracts the light representing the image 112 into one or more diffractive orders. For example, light ray 108, which is one of the light rays representing a portion of the bottom of the image, is diffracted by the in-coupler 106, and one of the diffracted orders 110 (e.g. the second order) is at an angle that is capable of being propagated through the waveguide 104 by total internal reflection.

At least a portion of the light 110 that has been coupled into the waveguide 104 by the diffractive in-coupler 106 is coupled out of the waveguide by a diffractive out-coupler 114. At least some of the light coupled out of the waveguide 104 replicates the incident angle of light coupled into the waveguide. For example, in the illustration, out-coupled light rays 116a, 116b, and 116c replicate the angle of the in-coupled light ray 108. Because light exiting the out-coupler replicates the directions of light that entered the in-coupler, the waveguide substantially replicates the original image 112. A user's eye 118 can focus on the replicated image.

In the example of FIG. 1A, the out-coupler 114 out-couples only a portion of the light with each reflection allowing a single input beam (such as beam 108) to generate multiple parallel output beams (such as beams 116a, 116b, and 116c). In this way, at least some of the light originating from each portion of the image is likely to reach the user's eye even if the eye is not perfectly aligned with the center of the out-coupler. For example, if the eye 118 were to move downward, beam 116c may enter the eye even if beams 116a and 116b do not, so the user can still perceive the bottom of the image 112 despite the shift in position. The out-coupler 114 thus operates in part as an exit pupil expander in the vertical direction. The waveguide may also include one or more additional exit pupil expanders (not shown in FIG. 1A) to expand the exit pupil in the horizontal direction.

In some embodiments, the waveguide 104 is at least partly transparent with respect to light originating outside the waveguide display. For example, at least some of the light 120 from real-world objects (such as object 122) traverses the waveguide 104, allowing the user to see the real-world objects while using the waveguide display. As light 120 from real-world objects also goes through the diffraction grating 114, there will be multiple diffraction orders and hence multiple images. To minimize the visibility of multiple images, it is desirable for the diffraction order zero (no deviation by 114) to have a great diffraction efficiency for light 120 and order zero, while higher diffraction orders are lower in energy. Thus, in addition to expanding and out-coupling the virtual image, the out-coupler 114 is preferably configured to let through the zero order of the real image. In such embodiments, images displayed by the waveguide display may appear to be superimposed on the real world.

In some embodiments, as described in further detail below, a waveguide display includes more than one waveguide layer. Each waveguide layer may be configured to preferentially convey light with a particular range of wavelengths and/or incident angles from the image generator to the viewer.

As illustrated in FIGS. 1B and 1C, waveguide displays having in-couplers, out-couplers, and pupil expanders may have various different configurations. An example layout of one binocular waveguide display is illustrated in FIG. 1B. In the example of FIG. 1B, the display includes waveguides 152a, 152b for the left and right eyes, respectively. The waveguides include in-couplers 154a, b, pupil expanders 156a,b, and components 158a,b, which operate as both out-couplers and horizontal pupil expanders. The pupil expanders 156a,b are arranged along an optical path between the in-coupler and the out-coupler. An image generator (not shown) may be provided for each eye and arranged to project light representing an image on the respective in-coupler.

An example layout of another binocular waveguide display is illustrated in FIG. 1C. In the example of FIG. 1C, the display includes waveguides 160a, 160b for the left and right eyes, respectively. The waveguides include in-couplers 162a,b. Light from different portions of an image may be coupled by the in-couplers 162a,b to different directions within the waveguides. In-coupled light traveling toward the left passes through pupil expanders 164a,b, while in-coupled light traveling toward the right passes through pupil expanders 166a,b. Having passed through the pupil expanders, light is coupled out of the waveguides using components 168a,b, which operate as both out-couplers and vertical pupil expanders to substantially replicate an image provided at the in-couplers 162a,b.

In different embodiments, different features of the waveguide displays may be provided on different surfaces of the waveguides. For example (as in the configuration of FIG. 1A), the in-coupler and the out-coupler may both be arranged on the anterior surface of the waveguide (away from the user's eye). In other embodiments, the in-coupler and/or the out-coupler may be on a posterior surface of the waveguide (toward the user's eye). The in-coupler and out-coupler may be on opposite surfaces of the waveguide. In some embodiments, one or more of an in-coupler, an out-coupler, and a pupil expander, may be present on both surfaces of the waveguide. The image generator may be arranged toward the anterior surface or toward the posterior surface of the waveguide. The in-coupler is not necessarily on the same side of the waveguide as the image generator. Any pupil expanders in a waveguide may be arranged on the anterior surface, on the posterior surface, or on both surfaces of the waveguide. In displays with more than one waveguide layer, different layers may have different configurations of in-coupler, out-coupler, and pupil expander.

FIG. 1D is a schematic exploded view of a double waveguide display according to some embodiments, including an image generator 170, a first waveguide (WG1) 172, and a second waveguide (WG2) 174. FIG. 1E is a schematic side-view of a double waveguide display according to some embodiments, including an image generator 176, a first waveguide (WG1) 178, and a second waveguide (WG2) 180. The first waveguide includes a first transmissive diffractive in-coupler (DG1) 180 and a first diffractive out-coupler (DG6) 182. The second waveguide has a second transmissive diffractive in-coupler (DG2) 184, a reflective diffractive in-coupler (DG3) 186, a second diffractive out-coupler (DG4) 188, and a third diffractive out-coupler (DG5) 190. Different embodiments may use different arrangements of optical components (such as different arrangements of pupil expanders) on the first and second waveguides.

While FIGS. 1A-1E illustrate the use of waveguides in a near-eye display, the same principles may be used in other display technologies, such as head up displays for automotive or other uses.

### Effects of Exit Pupil Expanders on Field of View.

FIG. 1F schematically illustrates a portion of the optical architecture of a waveguide type AR glass, including an in-coupler which is the round shape, and the exit pupil expander (EPE), which is the rotated rectangle. Both elements are diffractive optical elements (DOE) that are set at the surface of a glass wafer which acts as a combiner for an AR system: it is waveguiding the virtual image while it transmits the real image.

As such, the in-coupler receives the light beams from a light engine, the light beams are passing through the exit pupil of an optical system projecting the image. The exit pupil is matched to the in-coupler and the latter is configured to deviate the image by diffraction, into the glass wafer, at angles that permit the image to be guided inside of the waveguide by total Internal Reflection (TIR).

In order to combine the virtual and real image, it is desirable to deflect the virtual image light path. In free space optics, this is done with a mirror, whereas in the AR domain, it is not feasible to insert a mirror into the waveguide. Moreover, it is also desirable to expand the eyebox, and the double functionality of the EPE to deviate the light and expand the eyebox in one dimension is done using a diffraction grating which may be described as set in a conical mount.

While rays are propagating inside of the waveguide at angles between a critical angle (TIR), and grazing angle (typically chosen to be high but not too close to 90°), when some rays are diffracted by the EPE, they can diffract with a polar angle which is below the critical angle, and hence, those rays will leak.

It has been observed that the EPE reduces the vertical field of view of the system. Even if the horizontal FOV of the in-coupler is large, it may not be possible to take advantage of that FOV. As the vertical FOV is limited and as the imagers have an aspect ratio, the first component that will limit the overall FOV is the EPE.

In FIG. 1F, there is a coordinate system provided. The z-component is pointing out of the figure. “Polar” angle will refer to the angle between a ray and the z-axis, while “azimuth” will refer to the angle with the x-axis of the projection of the ray on the x-y plane.

Once the image has been in-coupled inside of the waveguide by the in-coupler, the polar angles of light inside the waveguide range between the critical angle and the grazing angle. The critical angle is:

$${θ}_{c} = {sin}^{- 1} \frac{1}{n}$$

where n is the index of the waveguide. For the grazing polar angle, it is design dependent and can be set between, for example, 65° and 90°.

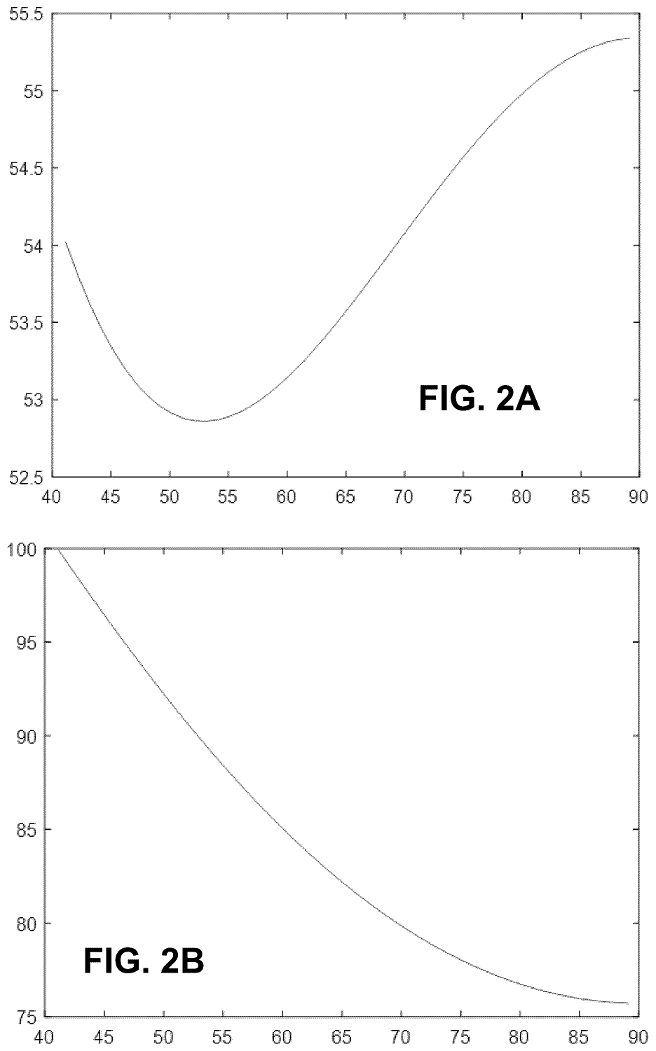

FIG. 2A illustrates polar angles after diffraction by the EPE, and FIG. 2B illustrates azimuth angles after diffraction by the EPE, for rays with an initial azimuth angle of 0°. Both curves are illustrated as a function of the incident polar angle on the EPE from inside of the waveguide.

FIGS. 2A-2B illustrate the case where a ray is propagating inside of the waveguide with an azimuth angle of 0°, and various polar angles from the critical angle to the grazing one, and where the ray is subsequently diffracted to various azimuth and polar angles. It may be seen that the diffracted rays will all have a polar angle which is above the critical angle in any case (the critical angle for n=1.52 is 41.2° for instance). This indicates that after being diffracted by the EPE, the ray will still propagate by total internal reflection. The diffracted azimuth angle is on average equal to 90° which indicates a right angle deviation for the image. The EPE's grating vector may be at 45° for that case.

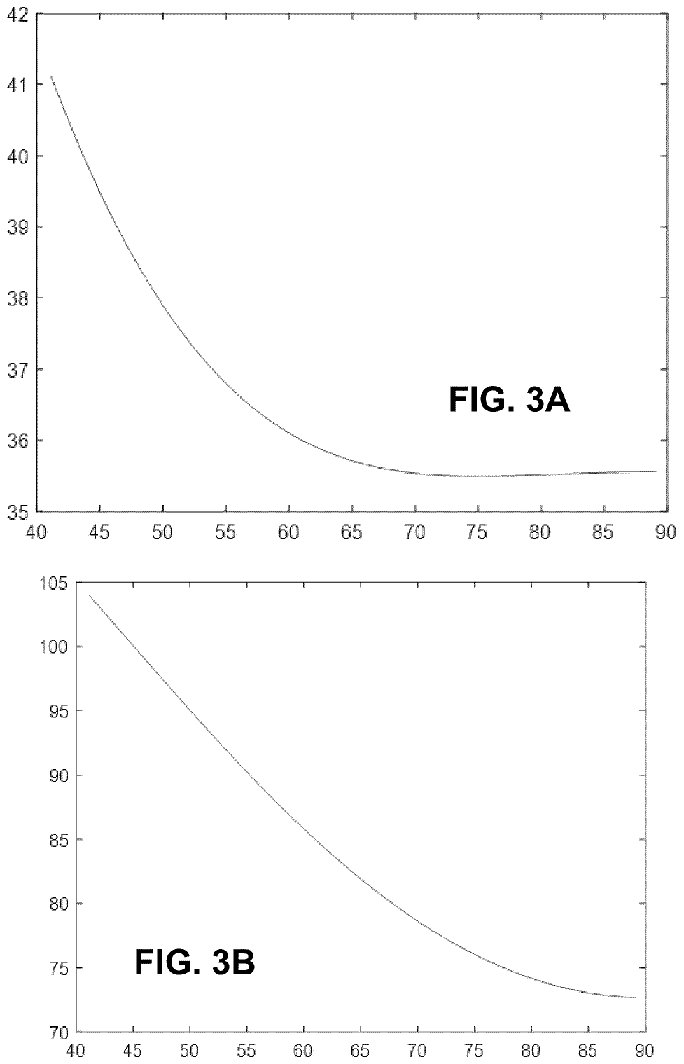

FIG. 3A illustrates polar angles after diffraction by the EPE, and FIG. 3B illustrates azimuth angles after diffraction by the EPE, for rays with an initial azimuth angle of −14°. Both curves are illustrated as a function on the incident polar angle on the EPE from inside of the waveguide.

It can be seen in FIGS. 3A-3B that, while the azimuth is still on average 90°, all of the diffracted ray polar angles are below the critical angle for total internal reflection. As a result, those rays will not stay entirely in the waveguide; instead, they will leak out once they hit a bare waveguide face.

The problem of post-EPE leakage may further be understood with reference to the complete polar and azimuthal range.

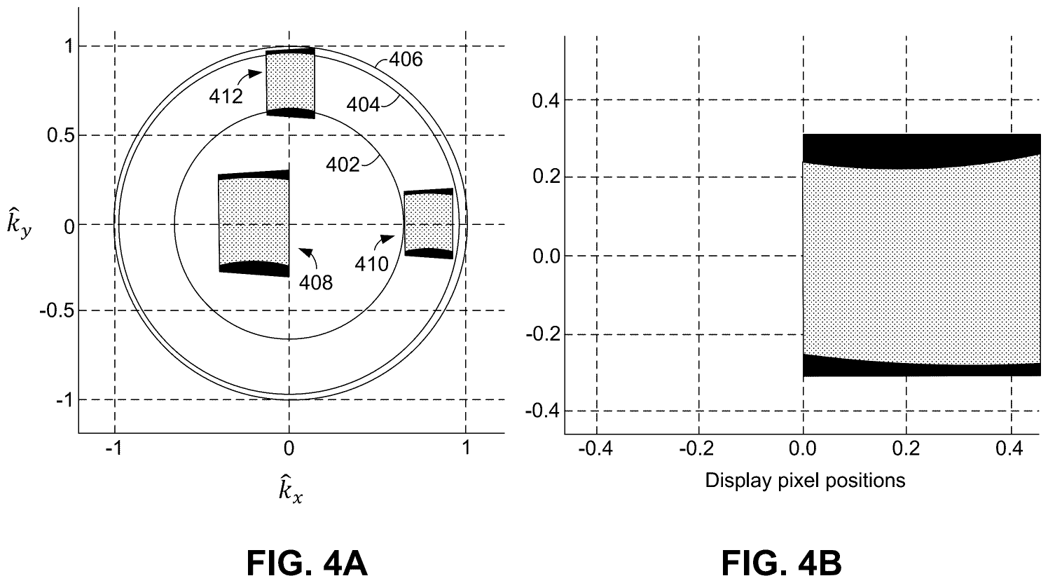

FIG. 4A is a k-vector diagram illustrating relative values of wavevectors processed by a waveguide. Circle 402 indicates the wavevector magnitude |\hat{k}ₓ+\hat{k}_{y}|corresponding to the critical angle. Circle 404 indicates the wavevector magnitude corresponding to the grazing angle. Circle 406 indicates the wavevector magnitude corresponding to evanescent waves. To be usefully propagated through the waveguide, a ray of light should have a wavevector magnitude that falls between circles 402 and 404, indicating an angle that is great enough to be propagated by total internal reflection but that is less than a grazing angle.

Region 408 illustrates a range of wavevectors of light (e.g. from the exit pupil of an image generator) that is incident on an in-coupler. Region 410 illustrates the resulting range of wavevectors after diffraction by the in-coupler. Region 412 illustrates the range of wavevectors after the in-coupled rays are diffracted by an EPE. It can be seen in region 412 that an upper portion (illustrated in black) has angles beyond the grazing angle and a lower portion (also illustrated in black) has angles that are below the critical angle. Thus, only wavevectors in the dotted portion (of all three regions 408, 410, 412) can usefully be propagated through the waveguide. FIG. 4B illustrates regions of a display that are propagated (dotted region) and not propagated (black region) through a waveguide. FIGS. 4A and 4B thus illustrate the effects of an EPE on limiting the vertical field of view of the display.

In some cases, the region 408 may represent only half of the in-coupled field of view, with the other half being diffracted to negative values of Rx. For simplicity, the other half of the field of view is not illustrated in FIGS. 4A-4B.

### Embodiments Using a Holographic Optical Element.

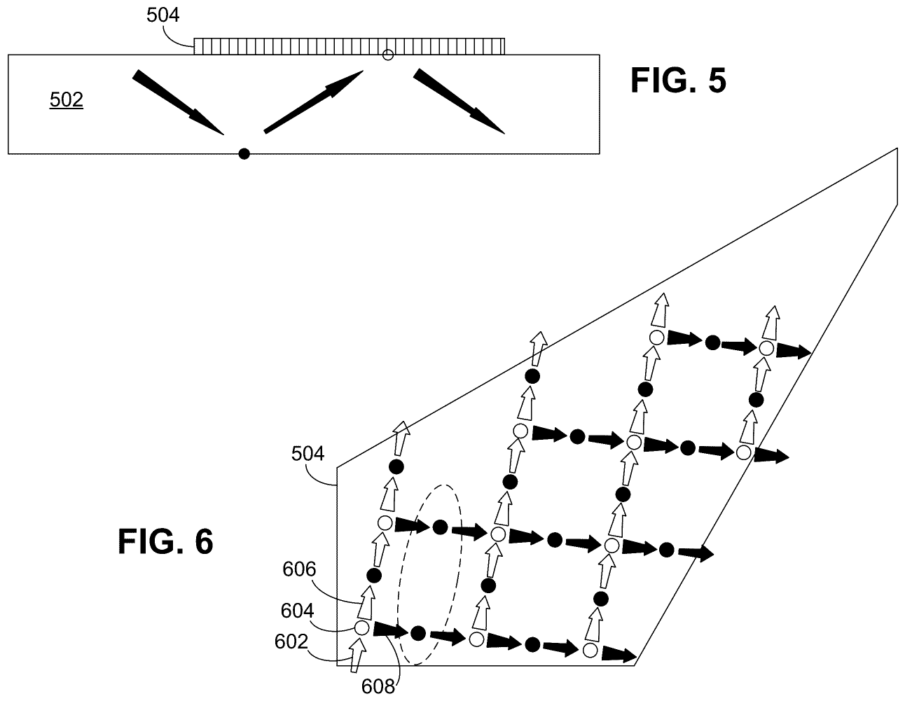

FIG. 5 is a schematic side view of a waveguide (WG) region 502 with an EPE 504, provided to help with understanding of FIG. 6. In both FIGS. 5 and 6, a region where light strikes the EPE surface of the waveguide is illustrated with an open circle, and a region where light strikes an opposite surface (e.g. bare glass) is illustrated with a solid circle.

FIG. 6 is a schematic top view of an EPE region of a waveguide. Light enters the EPE region from the bottom left. Light that hits the bare glass surface (solid circles) is reflected but not deflected. Light that hits the EPE surface may be reflected with order zero or reflected and deflected with a non-zero order (e.g. second order, in some embodiments). The path of light that has been deflected an even number of times (including zero times) is illustrated by open arrows, while light that has been deflected an odd number of times is illustrated by solid arrows.

As noted above with respect to FIGS. 4A-4B, light is particularly subject to loss (the black areas of region 412) after deflection by an EPE. With reference to FIG. 6, some of the light striking the glass within the dotted ellipse may have an angle lower than the critical angle and may escape the waveguide.

The EPE from FIG. 6 can be used in two ways. The output may be the light exiting the EPE toward the right, in which case the EPE is expanding the pupil and deviating the image. The second option is to use light exiting toward the top. In this case, the EPE is only expanding but not deviating the light. The decision on which way to adopt is dictated by the overall system geometry. In a C-shape architecture, it is desirable to use an EPE with deviation. In a system that does not in-couple in a dual side mode, there is no need to deviate the image path in the waveguide, and the transmitted path can be used.

In practice, it is the balance in diffraction efficiencies between the zero order diffraction and the conical-diffraction that is adjusted in order to follow one path of the other one.

In FIG. 6, an in-coupled ray 602 hits the EPE. At the first open circle 604 indicating a first hit of the EPE, the grating is designed such that there are two diffracted rays: the zero order 606 going upward, illustrated with an open arrow, and the conical diffracted one (e.g. first order, second order, etc.), illustrated with a solid arrow 608, that gets deviated.

The zero order diffracted ray 606 will have the same polar angle as the in-coming ray, and hence it will always be in TIR. On the other hand, the conical diffracted ray 608 could be below the critical polar angle as described above. If it is below the critical angle, the next time the ray hits the bare waveguide's face, it can leak and it will be lost, and the vertical field of view will be limited.

To avoid the undesired loss of light, example embodiments include a reflective holographic optical element (HOE) on the waveguide face opposite the EPE. The holographic optical element may be laminated to the surface of the waveguide.

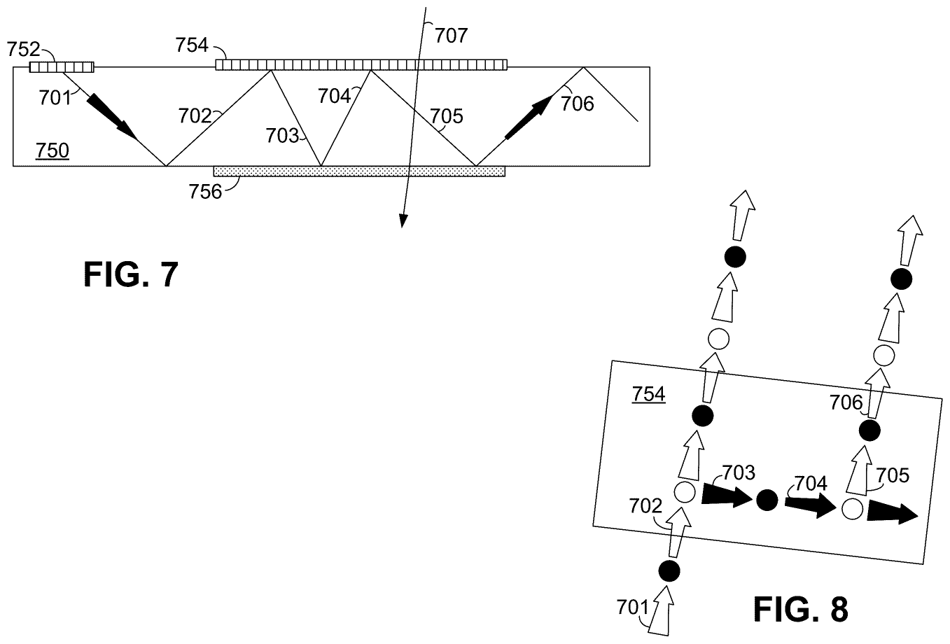

FIG. 7 illustrates the ray handling with this example system. FIG. 8 is a schematic top view of that system with tagged ray branches.

FIG. 7 is a schematic side view of an example waveguide 750 with an in-coupler 752, an EPE 754, and an anti-leak HOE component 756. The diffraction at the EPE is an out of plane one and for the sake of clarity, the zero order has not been drawn. The ray propagating inside of the waveguide is illustrated with tagged ray branches. Ray 701 is the in-coupled ray propagating through TIR. Ray 702 is ray 701 after reflection from the bottom surface, still in TIR. Ray 703 has been diffracted by the EPE to an angle below the critical angle for TIR, and it is incident on the HOE. Although ray 703 is below the critical angle, the HOE is configured to reflect ray 703, resulting in ray 704. Ray 705 is diffracted by the EPE, resulting through the reciprocity property in the same polar angle as ray 701 and 702, which again propagates through total internal reflection (ray 706). Ray 707 is a ray of ambient light, e.g. from the exterior of the display. Ray 707 is transmitted through the waveguide and is not reflected by the HOE because it is not within the range of angles that the EPE is configured to reflect and/or it does not have a wavelength that the EPE is configured to reflect. The transmission of ambient light through the HOE allows a better view of the user's eyes and conversely allows the user a better view of the ambient environment. Transparency to the exterior environment is not perfect, however, as some light from the exterior of the waveguide may coincidentally have angles and/or wavelengths corresponding to those that the HOE is configured to reflect.

FIG. 8 is a top view of a portion of the EPE region of waveguide 752. The light that strikes the HOE between rays 703 and 704 will be substantially reflected by the HOE rather than leaking from the waveguide. There will not be leakage between 705 and 606 because those branches are in total internal reflection again, while after 706, the polar angle will remain the same as 702 and will be reflected by total internal reflection.

The EPE and HOE may be configured to be substantially transparent to light from the real-world environment. Such a configuration provides benefits of a transparent waveguide, allowing people to see the user's eyes for comfortable communication and social interactions. While FIG. 7 illustrates the EPE on the top surface and the HOE on the bottom surface of the waveguide, these positions may be interchanged in some embodiments.

In some embodiments, the properties of the HOE can be described in terms of angular behavior. The HOE may be configured to be substantially transparent to light from the real world environment within the FOV while being reflective to narrowband light within the waveguide for angles below the critical angle and at least up to the critical angle.

The properties of a thick holographic optical element enable wavelength multiplexing as well as angle multiplexing. The hologram may be recorded to only diffract rays of certain incidence angle and/or of a certain wavelength. Consequently, the TIR-leaking rays can be targeted to be deviated by the HOE while the HOE remains transparent to other incident angles.

For instance, from FIGS. 3A-3B, it may be seen that in order to transmit the whole vertical angular FOV, the HOE may be configured to prevent leakages down to almost 35 degrees. The lowest value may be selected based on factors such as the desired vertical FOV and on the index of refraction of the waveguide. In some embodiments, the light used to transport the virtual image is narrowband light having wavelengths that are known to relatively precise values with some spectral spread. The spectral spread is characteristic of the light source used in the display. It can be extremely narrow for lasers and a little bit more spread for LEDs (some ±5 to ±10 nm).

In some embodiments, the HOE reflecting properties are asymmetrical also. With reference to FIG. 8, for instance, the branch 703 hits the HOE from the left. At each HOE hit, the light is incident from the left. Hence the HOE transmissivity can be made higher as it can be transparent when hit from the right hand side. Such a property would not be shared by use of a simple mirror in place of an HOE.

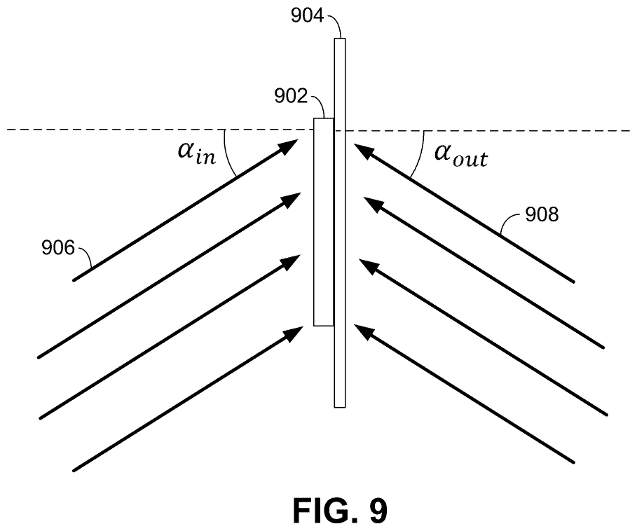

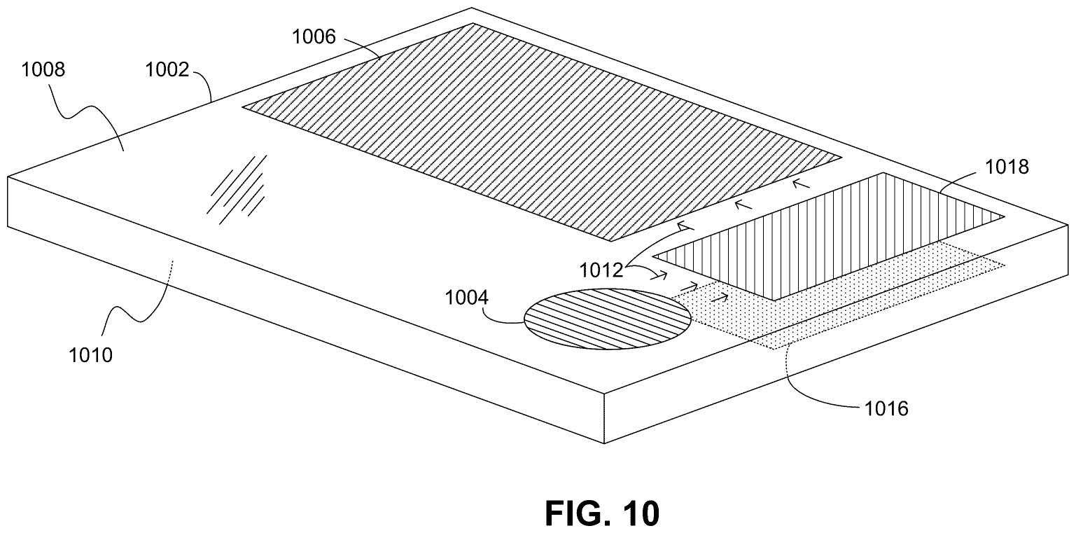

FIG. 9 is a schematic side view of a process of recording a holographic optical element using a holographic emulsion 902 on a glass plate 904. The process involves recording the interference of two plane waves normal to the hologram plate. The HOE is recorded so as to operate around a desired angle. To provide a narrow angular bandwidth of the hologram, the collimated reference beam 906 and the collimated object beam 908 may be tilted during the recording. αᵢₙ and αₒᵤₜ are respectively the expected incidence and reflected angles of the rays on the HOE inside the waveguide. αₒᵤₜ is the angle inside the glass plate. The refraction inside the glass may be taken into account.

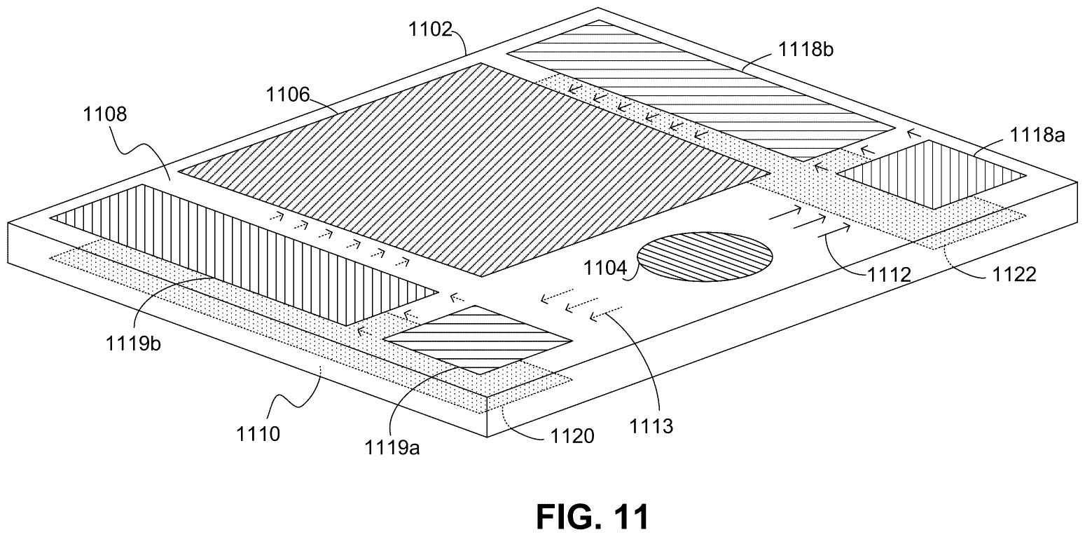

FIG. 10 is a schematic perspective view of a waveguide display according to some embodiments. The apparatus of FIG. 10 includes a waveguide 1002 having an in-coupler 1004 and an out-coupler 1006. The waveguide has a first surface 1008 and an opposite second surface 1010, the waveguide providing an optical path (illustrated by arrows 1012) from the in-coupler to the out-coupler. An exit pupil expander 1018 is positioned along the optical path on the first surface 1008. A holographic optical element 1016 is positioned on the second surface 1010 substantially opposite the exit pupil expander 1018. In some embodiments, one or more (or all) of the in-coupler, the exit pupil expander, and the out-coupler are diffraction gratings.

FIG. 11 is a schematic perspective view of a waveguide display according to some embodiments. The apparatus of FIG. 11 includes a waveguide 1102 having an in-coupler 1104 and an out-coupler 1106. The waveguide has a first surface 1108 and an opposite second surface 1110, the waveguide in this example providing two optical paths from the in-coupler to the out-coupler, one path illustrated by solid arrows 1112 and another path illustrated by dashed arrows 1113. In this example, there are two exit pupil expanders along each optical path: exit pupil expanders 1118a and 1118b along path 1112 and exit pupil expanders 1119a and 1119b along path 1113. In this example, holographic optical element 1120 is provided on the surface of the waveguide substantially opposite to the exit pupil expanders 1119a and 1119b, and holographic optical element 1122 is provided on the surface of the waveguide substantially opposite to the exit pupil expanders 1118a and 1118b. While the illustration shows each pair of exit pupil expanders sharing a single HOE, in some embodiments, separate HOEs may be provided for different EPEs. In some embodiments, not all of the EPEs have an associated HOE. In some embodiments, one or more (or all) of the in-coupler, the exit pupil expanders, and the out-coupler are diffraction gratings.

The holographic optical elements employed in example embodiments, such as HOEs 1016, 1120, and 1122, may be configured to operate as mirrors that are wavelength-selective and/or angularly selective. For example, the HOEs may be configured to selectively reflect light having a first characteristic and to selectively transmit light that does not have the first characteristic. In some embodiments, light having the first characteristic may be light having one or more of the following properties: an incident angle greater than a threshold angle (e.g. 35 degrees), a propagation direction along an optical path of the waveguide, and/or a wavelength of light that corresponds to a wavelength emitted by the image generator of the waveguide. In some embodiments, light that does not have the first characteristic may be light having one or more of the following properties: an incident angle less a threshold angle (e.g. 35 degrees), a propagation direction that does not correspond to an optical path of the waveguide, and/or a wavelength of light that does not correspond to any wavelength emitted by the image generator of the waveguide.

In some embodiments, the holographic optical element is configured to operate as a wavelength-selective mirror. A holographic optical element configured as a wavelength-selective mirror has a transmittance and reflectance that are dependent on the wavelength of incident light. In some embodiments, the reflectance of the holographic optical element has at least one peak (conversely, the transmittance has a minimum) at the wavelength of at least one color of light emitted by the corresponding image generator, and the reflectance decreases (the transmittance increases) as the wavelength is further from that used by the image generator.

In some embodiments, the holographic optical element is configured to operate as an angle-selective mirror. A holographic optical element configured as an angle-selective mirror has a transmittance and reflectance that are dependent on the angle of incident light. The transmittance and reflectance of an angle-selective mirror may depend on the angle of incidence, on the azimuth angle, or on both of those angles. In some embodiments, the reflectance of the holographic optical element is at a minimum (conversely, the transmittance is at a peak) for incident light with a low angle of incidence, and the reflectance increases (the transmittance decreases) for incident light that has a greater angle of incidence with the waveguide. Alternatively or additionally, in some embodiments, the reflectance of the holographic optical element is at a maximum for light with an azimuth angle directed along an optical path from the in-coupler to the out-coupler, and the reflectance decreases (the transmittance increases) as azimuth angles are further from being along an optical path from the in-coupler to the out-coupler.

With the use of a holographic optical element as a wavelength-selective mirror and/or as an angle-selective mirror, light that has originated at the image generator is more likely to be reflected for further propagation within the waveguide, whereas light that originated from the exterior scene is more likely to be transmitted through the holographic optical element and thus to exit the waveguide.

In some embodiments, an apparatus includes a waveguide with a first surface and an opposite second surface. The waveguide includes an in-coupler, an out-coupler, and at least one exit pupil expander along an optical path from the in-coupler to the out-coupler. The exit pupil expander is on a first surface of the waveguide, and a holographic optical element is provided on the second surface of the waveguide opposite at least a portion of the exit pupil expander. In some embodiments, the holographic optical element is configured to operate as a wavelength-selective mirror. In alternative embodiments, the holographic optical element is configured to operate as an angle-selective mirror. In still further embodiments, the holographic optical element is configured to operate both as a wavelength-selective mirror and as an angle-selective mirror.

An apparatus according to some embodiments comprises a waveguide having an in-coupler, an out-coupler, and at least one exit pupil expander along an optical path from the in-coupler to the out-coupler; and a holographic optical element on a surface of the waveguide substantially opposite the exit pupil expander, the holographic optical element being configured to selectively reflect light having a first characteristic and to selectively transmit light that does not have the first characteristic.

In some embodiments, the first characteristic comprises light having an incident angle greater than a threshold angle, such as 35 degrees. In some embodiments, light having the first characteristic comprises light having a propagation direction along the optical path from the in-coupler to the out-coupler. In some embodiments, light having the first characteristic comprises light having a selected wavelength.

In some embodiments, the apparatus further comprises an image generator, the in-coupler being configured to in-couple an image generated by the image generator. The image generator is configured to generate an image using light of at least one selected wavelength; and the first characteristic comprises light having the selected wavelength.

In some embodiments, the exit pupil expander is configured to deflect the optical path from the in-coupler to the out-coupler. In other embodiments, the exit pupil expander is configured to perform exit pupil expansion without deflecting the optical path from the in-coupler to the out-coupler.

In some embodiments, the exit pupil expander comprises a diffraction grating.

A method according to some embodiments comprises coupling light into an in-coupler of a waveguide having an out-coupler and at least one exit pupil expander along an optical path from the in-coupler to the out-coupler; and using a holographic optical element on a surface of the waveguide substantially opposite the exit pupil expander, selectively reflecting light having a first characteristic and selectively transmitting light that does not have the first characteristic.

Some embodiments further comprise permitting ambient light to enter the waveguide, wherein selectively transmitting light that does not have the first characteristic comprises selectively transmitting at least a portion of the ambient light.

Although features and elements are described above in particular combinations, one of ordinary skill in the art will appreciate that each feature or element can be used alone or in any combination with the other features and elements.

1. An apparatus comprising:
a waveguide having an in-coupler, an out-coupler, and at least one exit pupil expander along an optical path from the in-coupler to the out-coupler; and
a holographic optical element on at least a portion of a surface of the waveguide opposite the exit pupil expander;
wherein the holographic optical element is configured as at least one of a wavelength-selective mirror or an angle-selective mirror.

2. The apparatus of claim 1, wherein the apparatus further comprises an image generator, the in-coupler being configured to in-couple an image generated by the image generator, and wherein the holographic optical element is configured as a wavelength-selective mirror, a reflectance of the wavelength-selective mirror having at least one peak at a wavelength of light emitted by the image generator

3. The apparatus of claim 1, wherein the holographic optical element is configured as an angle-selective mirror, the angle-selective mirror having a reflectance that increases for increasing angle of incidence.

4. The apparatus of claim 3, wherein the angle-selective mirror is configured to substantially transmit light having an incident angle less than a threshold angle and to substantially reflect light having an incident angle greater than a threshold angle.

5. The apparatus of claim 4, wherein the threshold angle is 35 degrees.

6. The apparatus of claim 1, wherein the holographic optical element is configured as an angle-selective mirror having a reflectance that depends on an azimuth angle of incident light.

7. The apparatus of claim 6, wherein the angle-selective mirror has a maximum reflectance for light with an azimuth angle directed along an optical path from the in-coupler to the out-coupler.

8. The apparatus of claim 1, wherein the exit pupil expander comprises a diffraction grating.

9. A method comprising:
coupling light into an in-coupler of a waveguide having an out-coupler and at least one exit pupil expander along an optical path from the in-coupler to the out-coupler;
using a holographic optical element on at least a portion of a surface of the waveguide opposite the exit pupil expander, selectively reflecting or transmitting the light based on at least one of a wavelength of the light or an angle of the light.

10. The method of claim 9, further comprising emitting light from an image generator, the light coupled by the in-coupler including the emitted light, wherein the holographic optical element is configured as a wavelength-selective mirror, a reflectance of the wavelength-selective mirror having at least one peak at a wavelength of the light emitted by the image generator

11. The method of claim 9, wherein the holographic optical element is configured as an angle-selective mirror, the angle-selective mirror having a reflectance that increases for increasing angle of incidence.

12. The method of claim 11, wherein the angle-selective mirror is configured to substantially transmit light having an incident angle less than a threshold angle and to substantially reflect light having an incident angle greater than a threshold angle.

13. The method of claim 9, wherein the holographic optical element is configured as an angle-selective mirror having a reflectance that depends on an azimuth angle of incident light.

14. The method of claim 13, wherein the angle-selective mirror has a maximum reflectance for light with an azimuth angle directed along an optical path from the in-coupler to the out-coupler.

15. The method of claim 9, further comprising permitting ambient light to enter the waveguide, wherein the holographic optical element selectively transmits at least a portion of the ambient light.
